(19) United States
(12) Patent Application Publication
(10) Pub. No.: US 2002/0154362 A1
(43) Pub. Date: Oct. 24, 2002

(54) Optical link module

(76) Inventors: Kazushige Oki, Yokohama-shi (JP); Hiromi Kurashima, Yokohama-shi (JP)

Correspondence Address: MCDERMOTT WILL & EMERY, 600 13TH STREET, N.W., WASHINGTON, DC, 20005-3096, US

(21) Appl. No.: 10/105,621

(22) Filed: Mar. 26, 2002

(30) Foreign Application Priority Data
Mar. 27, 2001 (JP) P2001-090868

(51) Int. Cl. H04B 10/00

(52) U.S. Cl. 359/152

(57) ABSTRACT

An optical link module comprises a housing, in which a substrate is incorporated. The substrate is positioned above the bottom face of the housing. An optical transmitter and an optical receiver are accommodated in the housing. Lead pins of the optical transmitter and lead pins of the optical receiver are formed wavy. The optical transmitter is secured to wiring patterns formed on the substrate while in a state where the front and rear faces of the substrate are held between the lead pins. The optical receiver is secured to wiring patterns formed on the substrate while in a state where the front and rear faces of the substrate are held between the lead pins.

### BACKGROUND OF THE INVENTION

1. Field of the Invention

The present invention relates to an optical link module such as an optical transceiver.

2. Related Background Art

In general, an optical link module has a housing, in which a substrate is arranged. An optical transmitter for converting an electric signal into an optical signal, and an optical receiver for converting an optical signal into an electric signal are attached onto the substrate. The optical transmitter and receiver are connected to optical fibers by way of an optical connector and the like.

### SUMMARY OF THE INVENTION

If lead pins of the optical transmitter and receiver are secured to the substrate in a state where the optical transmitter and receiver are erected with respect to the substrate in the above-mentioned optical link module, the height of the module itself will increase. Therefore, in general, the lead pins of optical transmitter and receiver are bent, so that the optical transmitter and receiver are secured to the substrate while being laid parallel to the substrate. Since each lead pin must be bent in this case, however, operations of attaching the optical transmitter and receiver to the substrate take time and labor, thereby lowering the productivity.

It is an object of the present invention to provide an optical link module which can improve its workability and productivity.

In recent years, from the viewpoint of easily attaching/detaching an optical link module to/from a casing substrate, for example, the optical link module has been detachably attached to a receiving member (connector or the like) provided on the casing substrate instead of securing terminal pins provided on a substrate of the optical link module to the casing substrate. In such a configuration, for securing a sufficient strength in the optical link module when attached to the casing substrate, the substrate of the optical link module is often disposed above the housing bottom face within the housing of the optical link module. The present invention is based on such a background.

Namely, the present invention provides an optical link module comprising a housing, a substrate disposed in the housing, and an optical transmitter attached to the substrate; wherein the optical transmitter has a plurality of lead pins electrically connected to the substrate, and is configured such that front and rear faces of the substrate are held between the plurality of lead pins.

When attaching the optical transmitter to the substrate in this configuration of the present invention, the front and rear faces of the substrate are held between the plurality of lead pins of the optical transmitter. Preferably, in this state, the lead pins are secured by soldering or the like to wiring patterns formed on the front and rear faces of the substrate. Since it is thus unnecessary to bend the lead pins of the optical transmitter when attaching the optical transmitter to the substrate, the operation of attaching the optical transmitter becomes easier. This improves the productivity of optical link module. When the substrate is held between a plurality of lead pins as such, the optical transmitter is disposed beside the substrate, whereby no large space is necessary in terms of height, although the substrate is positioned above the housing bottom face.

Also, the present invention provides an optical link module comprising a housing, a substrate disposed in the housing, and an optical receiver attached to the substrate; wherein the optical receiver has a plurality of lead pins electrically connected to the substrate, and is configured such that front and rear faces of the substrate are held between the plurality of lead pins.

When attaching the optical receiver to the substrate in this configuration of the present invention, the front and rear faces of the substrate are held between the plurality of lead pins of the optical receiver. Preferably, in this state, the lead pins are secured by soldering or the like to wiring patterns formed on the front and rear faces of the substrate. Since it is thus unnecessary to bend the lead pins of the optical receiver when attaching the optical receiver to the substrate, the operation of attaching the optical receiver becomes easier. This improves the productivity of optical link module. When the substrate is held between a plurality of lead pins as such, the optical receiver is disposed beside the substrate, whereby no large space is necessary in terms of height, although the substrate is positioned above the housing bottom face.

Preferably, portions of the plurality of lead pins including leading end parts thereof are formed wavy. As a consequence, when the substrate is held between the leading end parts of a plurality of lead pins, it becomes easier for the lead pins to shrink thermally, thereby reducing the thermal stress occurring in soldered parts and roots of lead pins due to differences in coefficients of linear expansion between the package of optical transmitter or receiver or the lead pins and the substrate. This makes it harder to generate solder cracks and the like, thereby improving reliability. Also, the lead pins can be shortened when they are formed wavy as mentioned above. In this case, the impedance in lead pins decreases, whereby transmission signals can be restrained from deteriorating in the case where high speed data processing at 2.5 Gbps, for example, is carried out.

Preferably, the plurality of lead pins have such a spring characteristic that the front and rear faces of the substrate are urged in respective holding directions. This reliably brings the plurality of lead pins and the substrate into contact with each other, whereby the connectivity between the substrate and lead pins further improves.

Preferably, the plurality of lead pins include a ground line pin, a power line pin, and a signal line pin, the ground line pin and signal line pin being secured to one of the front and rear faces of the substrate, whereas the power line pin being secured to the other of the front and rear faces of the substrate. This allows an electrically advantageous wiring pattern to be formed on the front and rear faces of the substrate.

Preferably, the housing is constructed such that a receiving member to be connected to the substrate can be disposed on one side of the housing. This makes it easy to attach/detach the optical link module to/from the casing substrate, for example, by using the receiving member.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention may be more readily described with reference to the accompanying drawings, in which:

FIG. 1 is an exploded perspective view showing an embodiment of the optical link module in accordance with the present invention;

FIG. 2 is a sectional view showing the optical link module and apart to which the optical link module is connected;

FIGS. 3A and 3B are perspective views showing the exteriors of the optical transmitter and receiver shown in FIG. 1, respectively;

FIGS. 4A and 4B are views showing positions where lead pins in the optical transmitter and receiver shown in FIG. 2 are secured with respect to a substrate;

FIGS. 5A and 5B are side views showing states where lead pins of the optical transmitter shown in FIG. 2 are connected to the substrate;

FIG. 6 is a plan view of the optical link module shown in FIG. 1;

FIG. 7 is a perspective view showing the exterior of the optical link module shown in FIG. 1 and a casing; and

FIG. 8 is a sectional view showing an example of conventional optical link module.

### DESCRIPTION OF THE PREFERRED EMBODIMENTS

In the following, an optimum embodiment of the optical link module in accordance with the present invention will be explained with reference to the drawings.

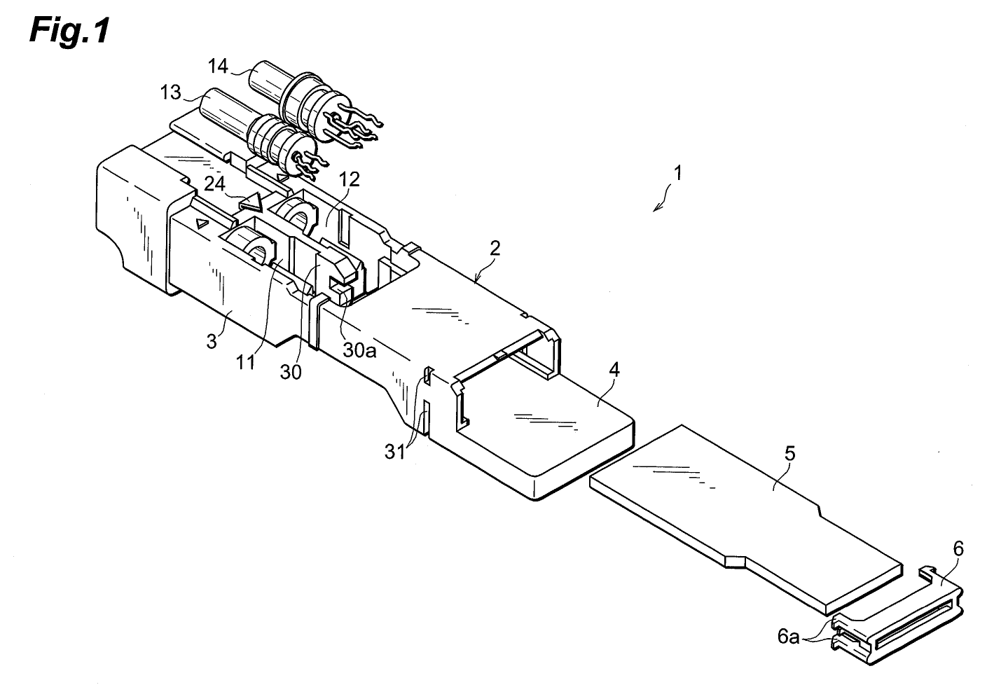

FIG. 1 is an exploded perspective view showing an embodiment of the optical link module in accordance with the present invention. In this drawing, an optical link module 1 comprises a housing 2, whereas the housing 2 has a housing body 3 and a host connector accommodating part 4 formed on one end side of the housing body 3.

A substrate 5 is incorporated in the housing 2. The housing body 3 of the housing 2 is provided with a partition 30, which is formed with a substrate guide groove 30a. The substrate 5 is accommodated into the housing body 3 from the host connector accommodating part 4 side, so as to be inserted into the substrate guide groove 30a. As a consequence, the vertical position of the substrate 5 is restricted. In this state, the substrate 5 is secured to an end part of the housing body 3 by a substrate holder 6. Both side faces of the housing body 3 are formed with holder engaging grooves 31, whereby the substrate holder 6 engages the housing body 3 when hooks 6a of the substrate holder 6 latch their corresponding holder engaging grooves 31.

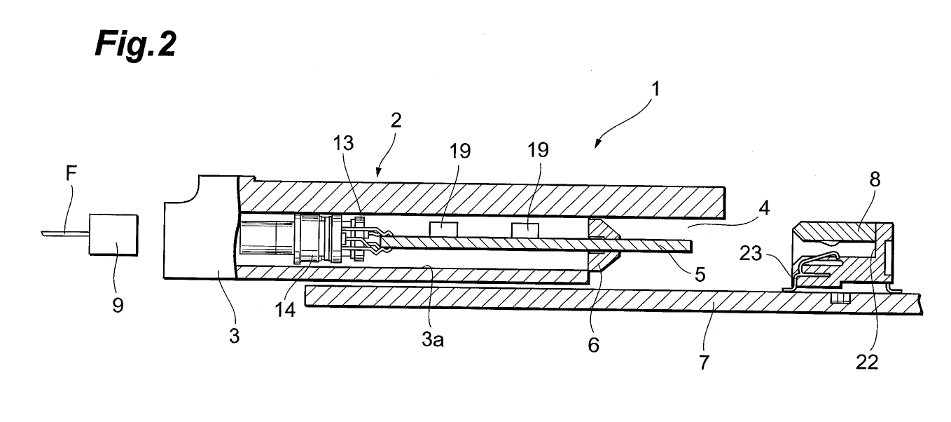

At that time, the substrate 5 is positioned above the bottom face 3a of the housing body 3 as shown in FIG. 2. Also, one end side of the substrate 5 projects from the housing body 3. When the optical link module 1 is attached to a substrate (hereinafter referred to as “casing substrate”) 7 provided in a casing (chassis), one end side of the substrate 5 is connected to a host connector 8 secured onto the casing substrate 7 while in a state where the host connector 8 is disposed at the host connector accommodating part 4.

As shown in FIG. 2, a pair of optical connector accommodating parts 10 (see FIG. 7), each accommodating an optical connector 9 connected to an optical fiber F, are arranged in parallel at the other end part of the housing body 3.

An optical transmitter accommodating part 11 and an optical receiver accommodating part 12 which are separated from each other by the partition 30 are arranged in parallel at respective positions corresponding to a pair of optical connector accommodating parts 10 in the housing body 3. A transmitter optical subassembly (TOSA; optical transmitter) 13 for converting an electric signal into an optical signal is accommodated in the optical transmitter accommodating part 11, whereas a receiver optical sub assembly (ROSA; optical receiver) 14 for converting an optical signal into an electric signal is accommodated in the optical receiver accommodating part 12. The transmitter optical subassembly 13 and receiver optical sub assembly 14 are secured to the housing body 3 by a support member which is not depicted.

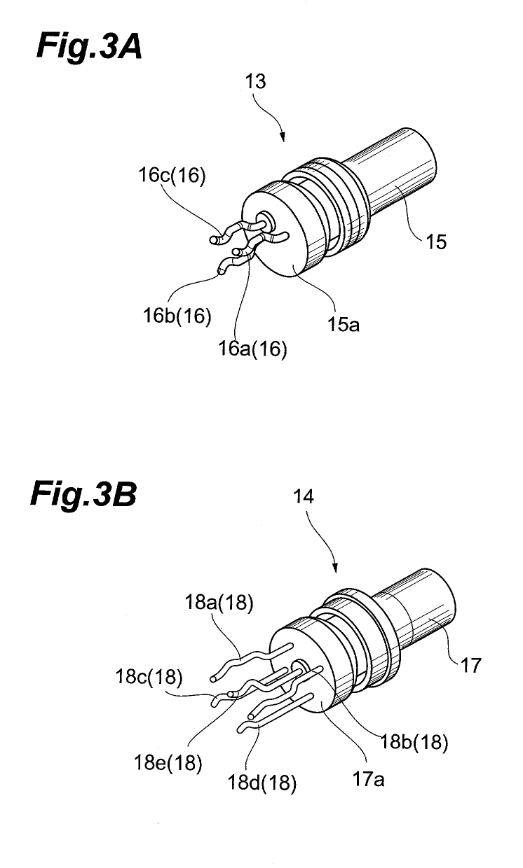

As shown in FIG. 3A, the transmitter optical sub assembly 13 comprises a package 15 having a light-emitting device (e.g., laser diode or light-emitting diode) and the like therein, and three lead pins 16 provided at a base 15a of the package 15. The lead pins 16 are a ground line pin 16a, a power line pin 16b, and a signal line (input data) pin 16c. Portions of the lead pins 16 including their leading end parts are subjected to lead forming beforehand so as to be bent wavy.

As shown in FIG. 3B, the receiver optical sub assembly 14 comprises a package 17 having a light-receiving device (e.g., photodiode), a preamplifier, and the like therein, and five lead pins 18 provided at a base 17a of the package 17. The lead pins 18 are two signal line pins 18a, 18b, two power line pins 18c, 18d (one of which is a light-receiving device power line), and one ground line (output data) pin 18e. Portions of the lead pins 18 including their leading end parts are also subjected to lead forming beforehand so as to be bent wavy.

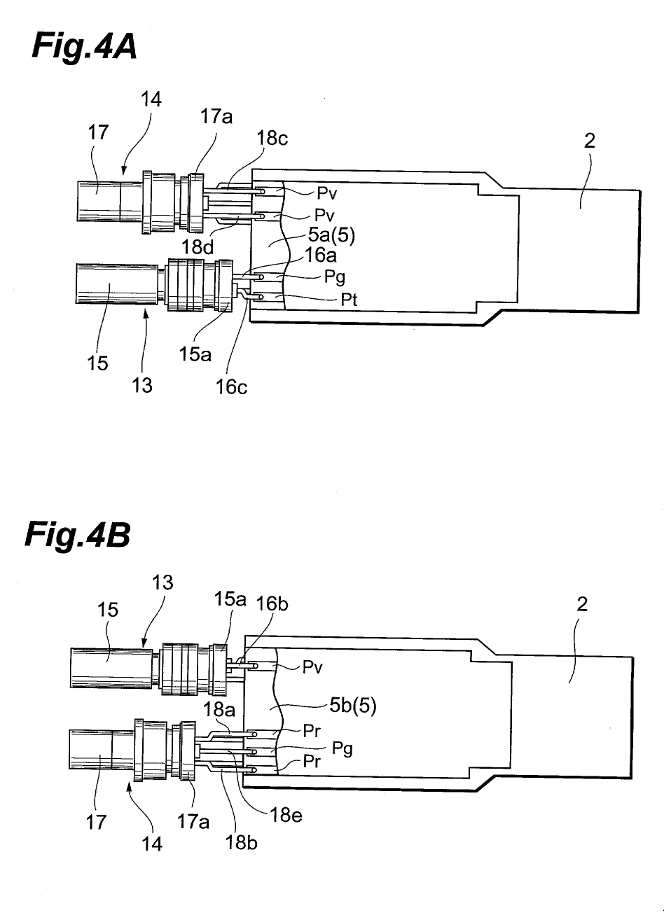

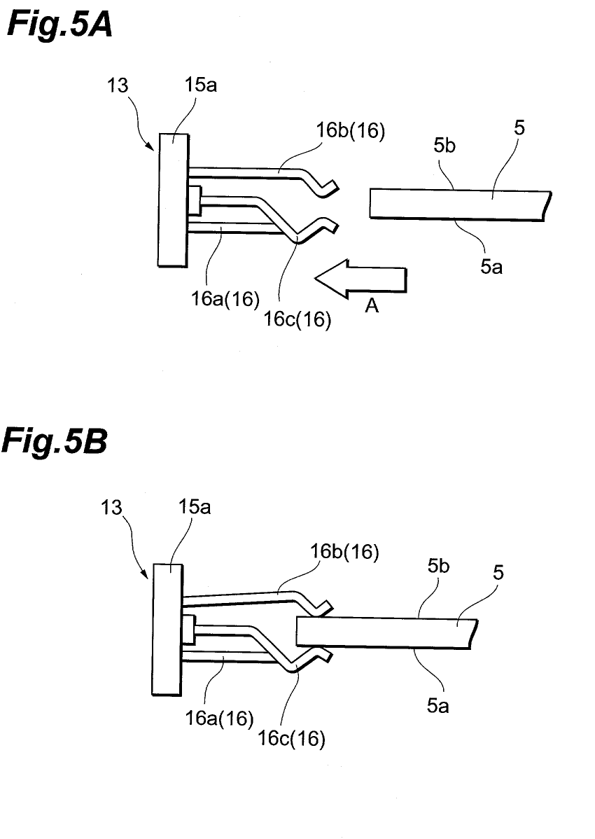

As shown in FIGS. 4A, 4B, 5A, and 5B, the transmitter optical sub assembly 13 is attached to the substrate 5 in a state where the substrate 5 is held between the three lead pins 16a to 16c. Specifically, while the transmitter optical sub assembly 13 is disposed on one side of the substrate 5, three lead pins 16a to 16c hold the substrate 5 therebetween and are secured by soldering or the like to their corresponding wiring patterns formed on the front face 5a and rear face 5b of the substrate 5.

Here, as shown in FIG. 4A, the front face 5a of the substrate 5 is formed with a ground line wiring pattern P_{g} and a signal line wiring pattern Pₜ. As shown in FIG. 4B, the rear face 5b of the substrate 5 is formed with a power line wiring pattern Pᵥ. The ground line pin 16a, signal line pin 16c, and power line pin 16b are electrically connected to the ground line wiring pattern P_{g}, signal line wiring pattern Pₜ, and power line wiring pattern Pᵥ, respectively.

As shown in FIGS. 4A and 4B, the receiver optical sub assembly 14 is attached to the substrate 5 in a state where five lead pins 18a to 18e hold the substrate 5 therebetween. Specifically, while the receiver optical sub assembly 14 is disposed in parallel with the transmitter optical sub assembly 13 on one side of the substrate 5, five lead pins 18a to 18e hold the substrate 5 therebetween, and the lead pins 18a to 18e are secured by soldering or the like to their corresponding wiring patterns formed on the front face 5a and rear face 5b of the substrate 5.

Here, as shown in FIG. 4A, the front face 5a of the substrate 5 is formed with two power line wiring patterns Pᵥ. As shown in FIG. 4B, the rear face 5b of the substrate 5 is formed with two signal line wiring patterns Pᵣ and a ground line wiring pattern P_{g}. The signal line pins 18a, 18b, ground line pin 18e, and power line pins 18c, 18d are electrically connected to the signal line wiring patterns Pᵣ, ground line pattern P_{g}, and power line wiring patterns Pᵥ, respectively.

Here, though the substrate 5 is positioned above the bottom face 3a of the housing body 3, it is not necessary for the housing body 3 to increase its height, since the transmitter optical sub assembly 13 and receiver optical sub assembly 14 are arranged beside the substrate 5.

Meanwhile, since two signal line wiring patterns Pᵣ are formed on both sides of the ground line wiring pattern P_{g} on the rear face 5b of the substrate 5, the signal lines are kept at a low impedance even when high speed data processing at 2.5 Gbps, for example, is performed, whereby reflections and distortions in signals and the like are suppressed. This effect increases as the wiring width of the ground line wiring pattern P_{g} is made thicker. Also, when forming a multilayer substrate, it will be effective if a plurality of ground line wiring patterns P_{g} are stacked between the front and rear faces of the substrate.

When the lead pins 16, 18 are formed wavy in such transmitter optical sub assembly 13 and receiver optical sub assembly 14, and the front face 5a and rear face 5b of the substrate 5 are held between the respective leading end parts of the lead pins 16, 18, it becomes easier for the lead pins 16, 18 to shrink thermally. This reduces the thermal stress occurring due to the difference in coefficients of linear expansion between the lead pins 16, 18 and the substrate 5. Also, the leadpins 16, 18 are attached to the package 15, 17 such that the inside of the package 15, 17 is sealed with a glass material. In this case, the thermal stress occurring in the roots of the glass-sealed lead pins 16, 18 due to differences in coefficients of linear expansion between the package 15, 17 or lead pins 16, 18 and the substrate 5 is also reduced. As a consequence, cracks are harder to occur in the roots and soldered parts of the lead pins 16, 18, whereby reliability increases.

Also, the lead pins 16, 18 can be shortened when they are formed wavy as mentioned above. In this case, impedance decreases in the lead pins 16, 18, whereby transmission signals can be restrained from deteriorating when high speed data processing at 2.5 Gbps, for example, is performed.

Preferably, the lead pins 16, 18 have such a spring characteristic that the front face 5a and rear face 5b of the substrate 5 are urged in their holding directions when attaching the transmitter optical sub assembly 13 and receiver optical sub assembly 14 to the substrate 5. In this case, when the substrate 5 is moved in the direction of A as shown in FIGS. 5A and 5B, for example, so that the lead pins 16a to 16c hold the substrate 5 therebetween, the lead pins 16a to 16c and the substrate 5 reliably come into contact with each other, thereby improving assembling characteristics.

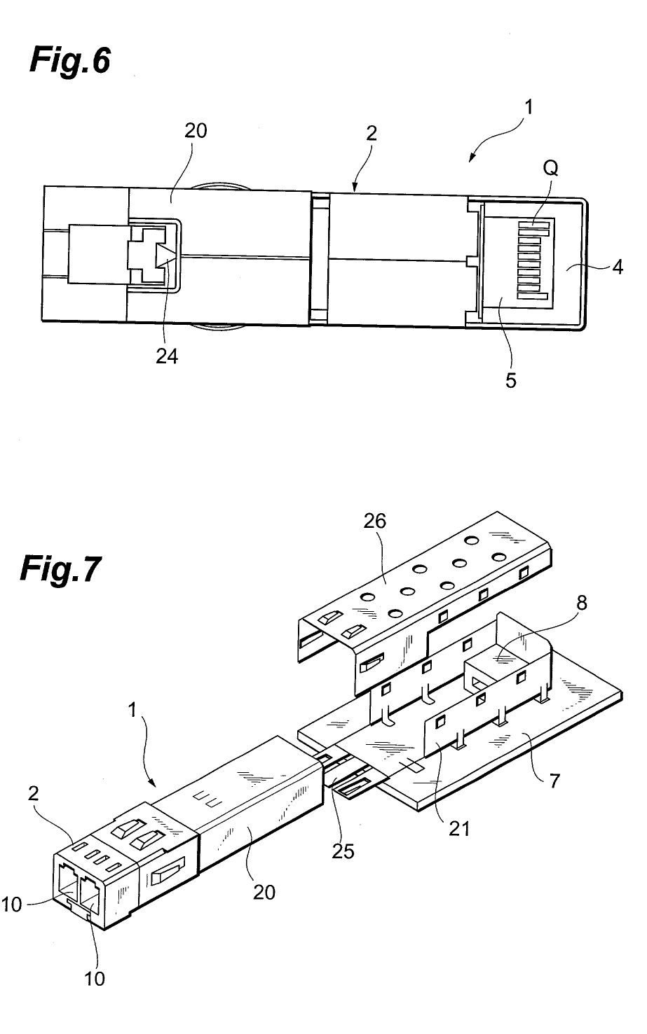

A plurality of wiring patterns Q such as those shown in FIG. 6 are formed on the front face 5a and rear face 5b at an end part on the side (projecting from the housing body 3) opposite from the side of substrate 5 to which the transmitter optical sub assembly 13 and receiver optical sub assembly 14 are secured as mentioned above. The wiring patterns Q include ground line wiring patterns, power line wiring patterns, signal line wiring patterns, and the like. Also, a plurality of electronic components 19 such as an amplifier are mounted on the substrate 5 (see FIG. 2). The housing 2 incorporating such a substrate 5 therein is covered with an EMI bracket 20 acting as an electromagnetic shield member.

Thus configured optical link module 1 is attached to the casing substrate 7 (mentioned above) as shown in FIG. 7. Secured onto the casing substrate 7 is a substantially box-shaped base part 21 for accommodating the optical link module 1. Disposed at a rear portion in the base part 21 is the host connector 8 (mentioned above). As shown in FIG. 2, the host connector 8 has a recess 22 adapted to mate with the substrate 5, whereas a side face part of the recess 22 is provided with a plurality of lead pins 23 to electrically connect with the wiring patterns Q of the substrate 5, whereas the lead pins 23 are soldered to the casing substrate 7.

The front portion of the base part 21 is provided with a lug 25 adapted to engage a stopper 24 (see FIG. 1) for securing the optical link module 1 to the base part 21. While the optical link module 1 is accommodated in the base part 21, and the substrate 5 is inserted into the recess 22 of the host connector 8, the stopper 24 is inserted into the lug 25. As a consequence, the optical link module 1 is held between the host connector 8 and the stopper 24, whereby a sufficient strength is secured.

After being held by the base part 21 as such, the optical link module 1 is covered with a lid 26. Here, the base part 21 and the lid 26 constitute an EMI cage acting as an electromagnetic shield member.

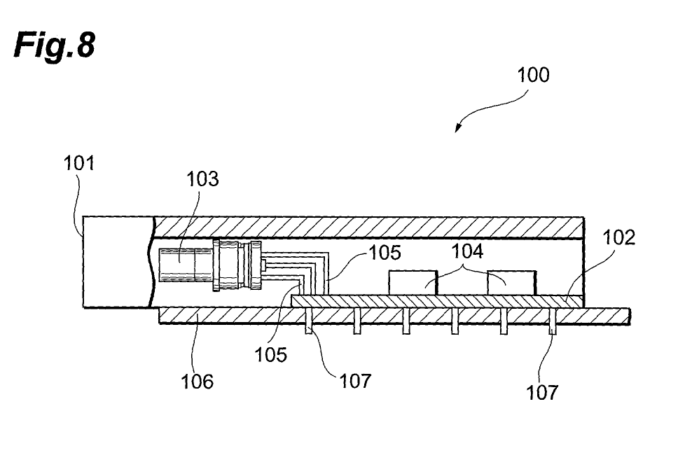

FIG. 8 shows an example of conventional optical link module. The optical link module 101 shown in this drawing has a housing 101, whereas a substrate 102 is provided at the bottom face of the housing 101. Mounted on the substrate 102 are an optical transmitter 103, an optical receiver (not depicted), electronic components 104, and the like. Lead pins 105 of the optical receiver 103 are bent substantially perpendicular. While in a state where the optical transmitter 103 is laid substantially parallel to the substrate 102, the lead pins 105 are inserted into and soldered to their corresponding holes formed in the substrate 102, whereby the optical transmitter 103 is secured to the substrate 102. The optical receiver is secured in a similar fashion.

In such an optical link module 100, it is necessary for each lead pin of the optical transmitter 103 to bend, whereby an operation of attaching the optical transmitter 103 to the substrate 102 takes time and labor. Also, when attaching the optical link module 100 to a casing substrate 106, a plurality of lead pins 107 of the substrate 102 penetrating through the housing 101 have to be secured to the casing substrate 106 by soldering or the like. Therefore, the operation of attaching the optical link module 100 is difficult. Further, when the electronic components 104 on the substrate 102 are broken, it is necessary for the substrate 102 to be removed from the casing substrate 106 in some cases, whereby it may take time and labor to replace the components.

When attaching the transmitter optical sub assembly 13 and receiver optical sub assembly 14 to the substrate 5 in the above-mentioned embodiment, by contrast, the substrate 5 is held between the lead pins 16, 18, which are made wavy beforehand by lead forming, and the lead pins 16, 18 are secured to wiring patterns formed on the front face 5a and rear face 5b of the substrate 5, whereby it becomes unnecessary for the lead pins 16, 18 to bend when attaching the transmitter optical sub assembly 13 and receiver optical sub assembly 14. As a consequence, operations of attaching the transmitter optical sub assembly 13 and receiver optical sub assembly 14 become easier, thereby improving the productivity of the optical link module 1. Also, since the electric connection between the substrate 5 of the optical link module 1 and the casing substrate 7 is established by way of the host connector 8, an operation of attaching the optical link module 1 to the casing can be carried out easily.

The optical link module in accordance with the present invention is not limited to the above-mentioned embodiment. For example, though the lead pins 16 of the transmitter optical sub assembly 13 and the lead pins 18 of the receiver optical sub assembly 14 are formed wavy in the above-mentioned embodiment, the lead pins 16, 18 are not limited to those having a wavy form in particular, but may be linear, for example. When the front face 5a and rear face 5b of the substrate 5 are held between a plurality of lead pins in the optical transmitter and optical receiver, operations of connecting the lead pins can be carried out easily in this case as well.

Though one optical link module 1 is provided with the transmitter optical sub assembly 13 and receiver optical sub assembly 14 in the above-mentioned embodiment, the present invention is also applicable to an optical link module equipped with an optical transmitter without an optical receiver, or an optical link module equipped with an optical receiver without an optical transmitter.

According to the present invention, since the front and rear faces of a substrate are held between a plurality of lead pins of an optical transmitter, an operation of attaching the optical transmitter to the substrate can be carried out easily, and the optical link module improves its productivity.

According to the present invention, since the front and rear faces of a substrate are held between a plurality of lead pins of an optical receiver, an operation of attaching the optical receiver to the substrate can be carried out easily, and the optical link module improves its productivity.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An optical link module comprising a housing, a substrate disposed in said housing, and an optical transmitter attached to said substrate;
wherein said optical transmitter has a plurality of lead pins electrically connected to said substrate, and is configured such that front and rear faces of said substrate are held between said plurality of lead pins.

2. An optical link module according to claim 1, wherein portions of said plurality of lead pins including leading end parts thereof are formed wavy.

3. An optical link module according to claim 1, wherein said plurality of lead pins have such a spring characteristic that said front and rear faces of said substrate are urged in respective holding directions.

4. An optical link module according to claim 1, wherein said plurality of lead pins include a ground line pin, a power line pin, and a signal line pin; and
wherein said ground line pin and signal line pin are secured to one of said front and rear faces of said substrate, whereas said power line pin is secured to the other of said front and rear faces of said substrate.

5. An optical link module according to claim 1, wherein said housing is constructed such that a receiving member to be connected to said substrate can be disposed on one side of said housing.

6. An optical link module comprising a housing, a substrate disposed in said housing, and an optical receiver attached to said substrate;
wherein said optical receiver has a plurality of lead pins electrically connected to said substrate, and is configured such that front and rear faces of said substrate are held between said plurality of lead pins.

7. An optical link module according to claim 6, wherein portions of said plurality of lead pins including leading end parts thereof are formed wavy.

8. An optical link module according to claim 6, wherein said plurality of lead pins have such a spring characteristic that said front and rear faces of said substrate are urged in respective holding directions.

9. An optical link module according to claim 6, wherein said plurality of lead pins include a ground line pin, a power line pin, and a signal line pin; and
wherein said ground line pin and signal line pin are secured to one of said front and rear faces of said substrate, whereas said power line pin is secured to the other of said front and rear faces of said substrate.

10. An optical link module according to claim 6, wherein said housing is constructed such that a receiving member to be connected to said substrate can be disposed on one side of said housing.
